(19) United States
(12) Patent Application Publication
(10) Pub. No.: US 2006/0187680 A1
(43) Pub. Date: Aug. 24, 2006

(54) NOTEBOOK COMPUTER, BACK LIGHT MODULE AND LIGHT GUIDE PLATE THEREOF

(76) Inventors: An-Ching Yen, Taipei County (TW); Cheng-Min Liao, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/906,501

(22) Filed: Feb. 23, 2005

(51) Int. Cl. F21V 7/04

(52) U.S. Cl. 362/634

(57) ABSTRACT

A system comprising a notebook computer, a back light module and a light guide plate. The notebook computer mainly comprises a host machine and a liquid crystal display hinged to that. The liquid crystal display further comprises a liquid crystal display panel and a back light module disposed underneath that. The back light module mainly comprises a plastic frame and a light guide plate. The plastic frame has a first contact surface and the light guide plate has at least a protruding ear with a second contact surface. The light guide plate is clamped within a plastic frame through the protruding ear. Because the contact between the first contact surface of the plastic frame and the second contact surface of the protruding ear is either a line contact or a point contact, the noise produced by friction between two when the liquid crystal display is lifted or shut is minimized.

### BACKGROUND OF THE INVENTION

1. Field of the Invention

The present invention relates to a computer, a light source module and a light guide plate. More particularly, the present invention relates to a notebook computer, a back light module and a light guide plate thereof.

2. Description of the Related Art

With the rapid progress in electronic technologies, functionally powerful and portable notebook computer now plays a very important role in the life of countless people both in business and in private. Most notebook computer uses a liquid crystal display to serve as the display monitor. However, because a liquid crystal display does not have a self-illuminating function, a back light module disposed underneath the liquid crystal display is often needed to provide the necessary illumination.

FIG. 1 is a perspective view of a conventional notebook computer. FIG. 2 is a schematic cross-sectional view of a portion of the back light module inside a conventional notebook computer. The notebook computer 20 in FIG. 1 mainly comprises a host machine 30 and a liquid crystal display 40. The liquid crystal display 40 is hinged to the host machine 30.

As shown in FIG. 2, the back light module 100 mainly comprises a plastic frame 110, a light guide plate 120 and a light source (not labeled). The light guide plate 120 has a protruding ear 122. The light guide plate 120 is positioned inside the plastic frame 110 through the protruding ear 122. The light source is disposed on the plastic frame 110. Furthermore, the plastic frame 110 has a contact surface 112 and the protruding ear 122 has a contact surface 122a.

As shown in FIGS. 1 and 2, there will be some relative movement between the plastic frame 110 and the light guide plate 120 when the liquid crystal display of the notebook computer 20 is lifted or shut. Because a surface contact is made between the contact surface 112a of the protruding ear 122 and the contact surface 112 of the plastic frame 110, noise is often generated due to friction between the protruding ear 122 and the plastic frame 110.

### SUMMARY OF THE INVENTION

Accordingly, at least one objective of the present invention is to provide a light guide plate that can effectively minimize the noise generated as a result of friction between the light guide plate and a plastic frame.

At least a second objective of the present invention is to provide a back light module having a light guide plate therein such that the noise generated as a result of friction between the light guide plate and a plastic frame can be effectively reduced.

At least a third objective of the present invention is to provide a notebook computer. The notebook computer has a liquid crystal display panel with a back light module comprising a light guide plate and a plastic frame such that the noise resulting from friction between the light guide plate and a plastic frame is minimized when the display panel is lifted or shut.

To achieve these and other advantages and in accordance with the purpose of the invention, as embodied and broadly described herein, the invention provides a light guide plate. The light guide plate has at least a protruding ear such that the light guide plate is clamped within a plastic frame through the protruding ear. The plastic frame has a first contact surface and the protruding ear has a second contact surface. Only a portion of the second contact surface is in contact with the first contact surface.

According to the embodiment of the present invention, the second contact surface of the protruding ear makes a line contact with the first contact surface of the plastic frame. In one embodiment, the second contact surface of the protruding ear is tilted with respect to the first contact surface of the plastic frame, for example. Alternatively, the second contact surface of the protruding ear of the light guide plate makes point contact with the first contact surface of the plastic frame. In one embodiment, the second contact surface of the protruding ear is a curved surface such as a spherical surface.

The present invention also provides a back light module comprising a plastic frame, a light guide plate and a light source. The plastic frame has a first contact surface and the light guide plate has a light incident side and at least a protruding ear. The light guide plate is clamped within the plastic frame through the protruding ear. The protruding ear has a second contact surface. A portion of the second contact surface is in contact with the first contact surface. In addition, the light source is disposed on the light incident side of the light guide plate.

The present invention also provides a notebook computer comprising a host machine and a liquid crystal display. The liquid crystal display is hinged to the host machine. Furthermore, the liquid crystal display mainly comprises a liquid crystal display panel and a back light module. The back light module is disposed underneath the liquid crystal display panel. The back light module has a structure identical to the aforesaid back light module and hence a detail description is omitted.

In the aforementioned back light module and notebook computer, the second contact surface of the protruding ear of the light guide plate makes a line contact with the first contact surface of the plastic frame, for example. In one embodiment, the second contact surface of the protruding ear is tilted with respect to the first contact surface of the plastic frame. Alternatively, the second contact surface of the protruding ear of the light guide plate makes point contact with the first contact surface of the plastic frame. In one embodiment, the second contact surface of the protruding ear is a curved surface such as a spherical surface.

Accordingly, very little noise is produced through friction between plastic frame and the light guide plate when the display panel of the notebook computer is lifted or shut. This is because only a small portion of the first contact surface of the plastic frame is in contact with the second contact surface of the protruding ear.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a perspective view of a conventional notebook computer.

FIG. 2 is a schematic cross-sectional view of a portion of the back light module inside a conventional notebook computer.

FIG. 3 is a perspective view of a notebook computer according to one embodiment of the present invention.

FIG. 4 is a side view of a portion of the back light module in FIG. 3.

FIG. 5 is a schematic cross-sectional view showing a portion of a back light module according to a first embodiment of the present invention.

FIG. 6 is a schematic cross-sectional view showing a portion of a back light module according to a second embodiment of the present invention.

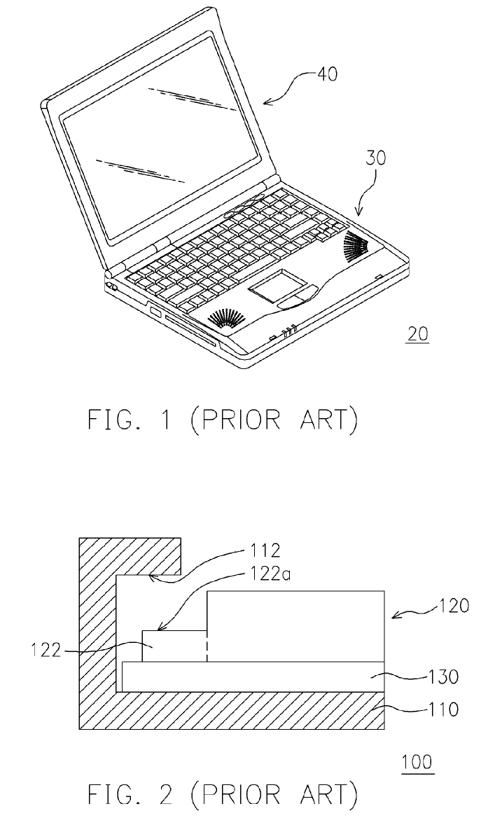

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

FIG. 3 is a perspective view of a notebook computer according to one embodiment of the present invention. The notebook computer 300 mainly comprises a host machine 310 and a liquid crystal display 320. The liquid crystal display 320 is hinged to the host machine 310. It should be noted that the method of hinging the liquid crystal display 320 to the host machine 310 is not limited to the one shown in FIG. 3. The liquid crystal display 320 further comprises a liquid crystal display panel 322 and a back light module 200. The back light module 200 is disposed underneath the liquid crystal display panel 322 to provide a planar light source for illuminating the liquid crystal display panel 322.

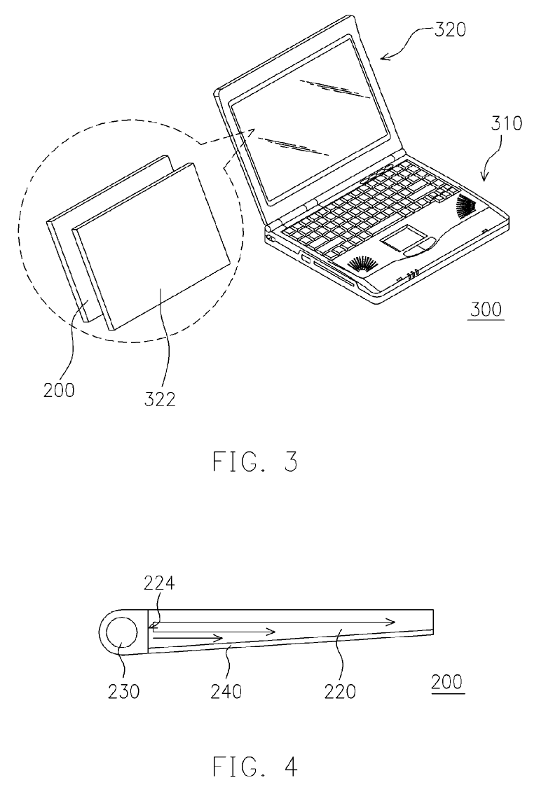

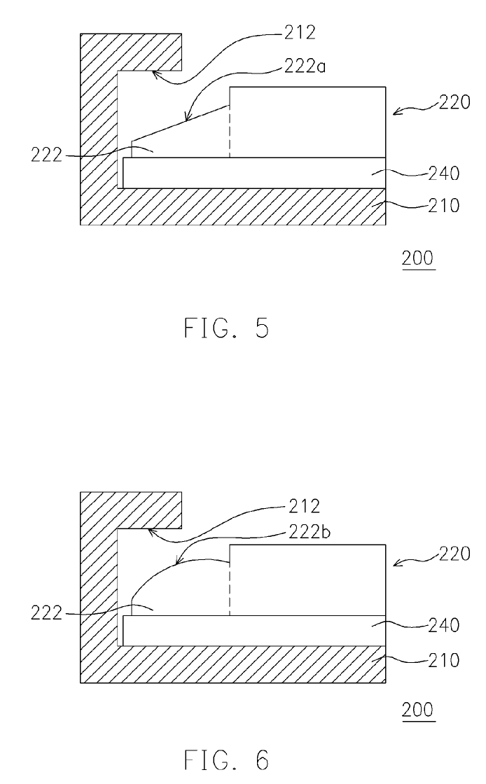

FIG. 4 is a side view of a portion of the back light module in FIG. 3. FIG. 5 is a schematic cross-sectional view showing a portion of a back light module according to a first embodiment of the present invention. As shown in FIGS. 4 and 5, the back light module 200 mainly comprises a plastic frame 210, a light guide plate 220 and a light source 230. The light guide plate 220 has at least a protruding ear 222 and the light guide plate 220 is clamped within the plastic frame 210 through the protruding ear 222. The plastic frame 210 has a first contact surface 212 and the protruding ear 222 has a second contact surface 222a. A portion of the second contact surface 222a is in contact with the first contact surface 212.

As shown in FIG. 4, the light guide plate 220 has a light incident side 224. The light source 230 is disposed on the light incident side 224 of the light guide plate 220. A beam of light from the light source 230 enters the light guide plate 220 from the light incident side 224 and then emerges from a light outputting surface (not labeled) of the light guide plate 220 to form a planar light source. In general, the light guide plate 220 has a wedge shape. Although a cold cathode fluorescent lamp (CCFL) is used as the light source 230 in FIG. 4, other type of light source such as an array of light-emitting diodes (LED) can be used inside the back light module 200 too.

In addition, the back light module 200 may further comprises a reflective plate 240 disposed between the light guide plate 220 and the plastic frame 210. The reflective plate 240 reflects light coming in from the light incident side 224 of the light guide plate 220 to produce a planar light source that emerges from the light outputting surface of the light guide plate 200.

As shown in FIGS. 3 and 5, the second contact surface 222a and the first contact surface 212 make a line contact with each other, for example. The way to form a line contact between the second contact surface 222a and the first contact surface 212 includes tilting the second contact surface 222a of the protruding ear 222 relative to the first contact surface 212 of the plastic frame 210. With the second contact surface 222a and the first contact surface 212 forming a line contact, frictional noise resulting from the relative movement between the plastic frame 210 and the light guide plate 220 when flipping the display panel of the notebook computer is minimized.

FIG. 6 is a schematic cross-sectional view showing a portion of a back light module according to a second embodiment of the present invention. The type of contact between the first contact surface 212 of the plastic frame 210 and the second contact surface 222b of the protruding ear 222 is not limited to a line contact as in the first embodiment, a point contact may also be used. In the second embodiment, the second contact surface 222b of the protruding ear 222 has a curved surface such as a spherical surface so that the second contact surface 222b can form a point contact with the first contact surface 212 of the plastic frame 210 (shown in FIG. 6).

It should be noted that the line contact and the point contact illustrated in FIGS. 5 and 6 are used as an example only and should by no means limit the scope of the present invention. Anyone familiar with the technologies may understand that the spirit of the present invention lies in minimizing the contact area between the second contact surface 222a (222b) of the protruding ear 222 with the first contact surface 212 of the plastic frame 210. Therefore, frictional noise produced by relative movement between the plastic frame 210 and the light guide plate 220 is minimized.

It should be noted that the application of the back light module of the present invention is not limited to a notebook computer. The present invention can also be applied to other types of products that require a back light module for illumination.

In summary, only a small portion of the first contact surface of the plastic frame is in contact with the second contact surface of the protruding ear in the present invention. Hence, the noise produced by the rubbing the plastic frame against the light guide plate when the display panel of the notebook computer is lifted or shut is minimized.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A light guide plate clamped within a plastic frame through at least a protruding ear on the light guide plate, wherein the plastic frame has a first contact surface and the protruding ear has a second surface such that a portion of the second contacts surface is in contact with the first contact surface.

2. The light guide plate of claim 1, wherein the first contact surface forms a line contact with the second contact surface.

3. The light guide plate of claim 2, wherein the second contact surface of the protruding ear is tilted with respect to the first contact surface of the plastic frame.

4. The light guide plate of claim 1, wherein the first contact surface forms a point contact with the second contact surface.

5. The light guide plate of claim 4, wherein the second contact surface of the protruding ear comprises a curve surface.

6. The light guide plate of claim 5, wherein the curve surface comprises a spherical surface.

7. A back light module, comprising:
a plastic frame having a first contact surface;
a light guide plate having a light incident side and at least a protruding ear, wherein the light guide plate is clamped within the plastic frame through the protruding ear and the protruding ear has a second contact surface such that the second contact surface is in contact with a portion of the first contact surface; and
a light source disposed on the light incident side of the light guide plate.

8. The back light module of claim 7, wherein the first contact surface forms a line contact with the second contact surface.

9. The back light module of claim 8, wherein the second contact surface of the protruding ear is tilted with respect to the first contact surface of the plastic frame.

10. The back light module of claim 7, wherein the first contact surface forms a point contact with the second contact surface.

11. The back light module of claim 10, wherein the second contact surface of the protruding ear comprises a curve surface.

12. The back light module of claim 11, wherein the curve surface comprises a spherical surface.

13. The back light module of claim 7, wherein the module further comprises a reflective plate disposed between the light guide plate and the plastic frame.

14. A notebook computer, comprising:
a host machine;
a liquid crystal display hinged to the host machine, wherein the liquid crystal display further comprises:
a liquid crystal display panel;
a back light module, having:
a plastic frame having a first contact surface;
a light guide plate having a light incident side and at least a protruding ear, wherein the light guide plate is clamped within the plastic frame through the protruding ear and the protruding ear has a second contact surface such that a portion of the second contact surface is in contact with the first contact surface; and
a light source disposed on the light incident side of the light guide plate.

15. The notebook computer of claim 14, wherein the first contact surface forms a line contact with the second contact surface.

16. The notebook computer of claim 1 5, wherein the second contact surface of the protruding ear is tilted with respect to the first contact surface of the plastic frame.

17. The notebook computer of claim 14, wherein the first contact surface forms a point contact with the second contact surface.

18. The notebook computer of claim 17, wherein the second contact surface of the protruding ear comprises a curve surface.

19. The notebook computer of claim 18, wherein the curve surface comprises a spherical surface.

20. The notebook computer of claim 14, wherein the computer further comprises a reflective plate disposed between the light guide plate and the plastic frame.
